(19) United States
(12) Patent Application Publication
(10) Pub. No.: US 2008/0297091 A1
(43) Pub. Date: Dec. 4, 2008

(54) Foot of walking robot and walking robot having the same

(75) Inventors: Joong Kyung Park, Suwon-si (KR); Tae Won Park, Suwon-si (KR); Ji Won Yoon, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/081,414

(22) Filed: Apr. 15, 2008

(30) Foreign Application Priority Data
May 31, 2007 (KR) 10-2007-0053167

(51) Int. Cl. B62D 57/00

(52) U.S. Cl. 318/568.12; 318/568.16; 901/1

(57) ABSTRACT

Disclosed are a foot of a walking robot, which minimizes tilting of a sole of the foot and reduces a degree of freedom to easily control the walking of the robot, and a walking robot having the same. The foot includes a frame connected to a lower portion of a leg of the walking robot; and a plurality of impact absorbing plates having elasticity respectively connected to two sides of the frame such that the impact absorbing plates are separated from each other. Each of the impact absorbing plates includes a separation part connected to the frame and separated from a ground surface, a front ground part extended forward from the separation part and contacting the ground surface, and a rear ground part extended backward from the separation part and contacting the ground surface.

### CROSS-REFERENCE TO RELATED APPLICATIONS

This application claims the benefit of Korean Patent Application No. 2007-0053167, filed May 31, 2007, in the Korean Intellectual Property Office, the disclosure of which is incorporated herein by reference.

### BACKGROUND

1. Field

The present invention relates to a walking robot, and more particularly, to a foot of a walking robot, which alleviates an impact applied to the foot when walking and minimizes an overthrow of the robot, and a walking robot having the same.

2. Description of the Related Art

A foot of a walking robot serves to provide a driving force through friction with the ground so that the robot can walk as well as support the weight of the body of the robot transmitted through a leg. This foot of the walking robot must alleviate an impact applied thereto when landing and achieve stable walking. Thus, research on feet of walking robots has been carried out.

Honda Motor Co., Ltd. in Japan has developed a foot of a walking robot, which alleviates an impact applied to the heel of the foot when walking. This technique is disclosed in U.S. Pat. Ser. No. 6,377,014. Such a foot of the walking robot includes a plurality of rigid members formed at the heel of the foot in the direction of gravity, and an elastic member interposed between the rigid members. Thus, the heel of the foot has rigidity against forces acting in a direction of a gravity axis, which is higher than rigidity against forces acting in other directions. Thereby, it is possible to alleviate an impact applied to the heel of the foot when landing and achieve stabilization of a posture after landing. Further, the foot of the walking robot has a simple shape, and thus reduces a degree of freedom, thereby allowing the walking of the robot to be easily controlled.

However, since the foot of the walking robot has a flat sole, the sole of the foot is tilted when the walking robot walks on the uneven ground or the ground having obstacles, and thus the walking robot cannot walk smoothly. In the case that the sole of the foot is severely tilted, the walking robot may lose its balance and fall.

Further, the foot of the walking robot has an impact absorbing part with a small thickness at the sole, and thus cannot effectively absorb an impact applied perpendicularly to the sole of the foot. Accordingly, in the case that an unexpected great impact is applied to the sole of the foot, the impact is transmitted to the ankle of the robot and causes damage to a multi-axis force and torque (F/T) sensor installed at the ankle.

### SUMMARY

Therefore, one aspect of the embodiments is to provide a foot of a walking robot, which minimizes tilting of the sole of the foot even when the walking robot walks on the uneven ground, and a walking robot having the same.

Another aspect of the embodiments is to provide a foot of a walking robot, which reduces a degree of freedom to easily control the walking of the robot, and alleviates impact applied to the foot in various directions when landing, and a walking robot having the same.

Additional aspects and/or advantages will be set forth in part in the description which follows and, in part, will be apparent from the description, or may be learned by practice of the invention.

The foregoing and/or other aspects are achieved by providing a foot of a walking robot to walk on a ground surface, the walking robot including a leg, the foot including a frame connected to a lower portion of the leg of the walking robot; and a plurality of impact absorbing plates having elasticity respectively connected to two sides of the frame such that the impact absorbing plates are separated from each other, each of the impact absorbing plates including a separation part connected to the frame and separated from the ground surface, a front ground part extended forward from the separation part and contacting the ground surface, and a rear ground part extended backward from the separation part and contacting the ground surface.

The front and rear ground parts of the impact absorbing plates may be separated from each other, and an upper portion of a separation region between the impact absorbing plates may be opened.

The foot may further include buffering members respectively attached to lower surfaces of the front and rear ground parts of the impact absorbing plates.

The buffering members may be made of rubber having elasticity.

The impact absorbing plates may be made of carbon fiber reinforced plastic (CFRP).

A ground area of the front ground parts at which the front ground parts contact the ground surface may be larger than a ground area of the rear ground parts at which the rear ground parts contact the ground surface.

A length of each of the front ground parts may be longer than a length of each of the rear ground parts.

The foregoing and/or other aspects are achieved by providing a walking robot, including a body; a plurality of legs connected to the body to cause the robot to walk on a ground surface; and feet respectively connected to lower portions of the legs, each of the feet including a frame connected to the lower portion of one of the legs of the walking robot, and a plurality of impact absorbing plates having elasticity respectively connected to two sides of the frame such that the impact absorbing plates are separated from each other, each of the impact absorbing plates including a separation part connected to the frame and separated from the ground surface, a front ground part extended forward from the separation part and contacting the ground surface, and a rear ground part extended backward from the separation part and contacting the ground surface.

The impact absorbing plates may be formed integrally such that a separation part of each of the impact absorbing plates is connected to a separation part of another of the impact absorbing plates at a connection part.

The foregoing and/or other aspects are achieved by providing a foot of a walking robot to walk on a ground surface and having a body, the foot including: at least one plate supporting the body of the walking robot, the plate having a separation part separated from the ground surface and a plurality of ground parts extending away from the separation part to contact the ground surface.

Each of the ground parts may include a buffering member having an elastic restoring force to cushion an impact of the foot contacting the ground surface.

A sensor may be connected between the foot and the body of the robot and may be supported by the plate, the sensor measuring three-dimensional components of a force and three-dimensional components of a moment transmitted from the foot.

The foot may further include a frame, the frame being supported by the at least one plate and supporting the sensor.

### BRIEF DESCRIPTION OF THE DRAWINGS

These and/or other aspects and advantages will become apparent and more readily appreciated from the following description of the embodiments, taken in conjunction with the accompanying drawings in which:

FIG. 1 is a perspective view schematically illustrating feet and legs of a walking robot, to which the present embodiments are applied;

FIG. 2 is a perspective view of a foot of a walking robot in accordance with a first embodiment;

FIG. 3 is a cross-sectional view of the foot of the walking robot of FIG. 2;

FIG. 4 is an exploded perspective view of the foot of the walking robot of FIG. 2;

FIG. 5 is a cross-sectional view of the foot of the walking robot of FIG. 2 in a walking state; and

FIG. 6 is an exploded perspective view of a foot of a walking robot in accordance with a second embodiment.

### DETAILED DESCRIPTION OF THE EMBODIMENTS

Reference will now be made in detail to the embodiments, examples of which are illustrated in the accompanying drawings, wherein like reference numerals refer to like elements throughout. The embodiments are described below to explain the present invention by referring to the annexed drawings.

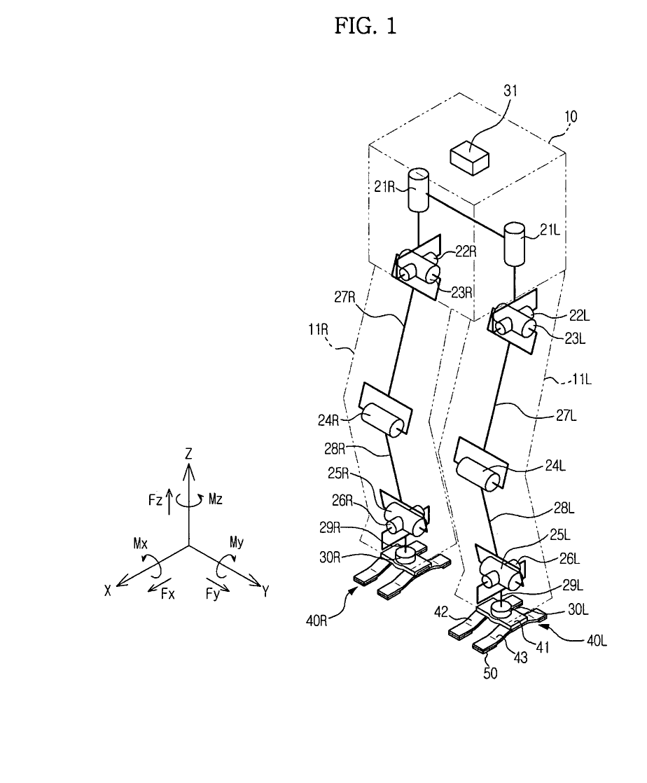

FIG. 1 is a perspective view schematically illustrating feet and legs of a walking robot, to which the present embodiments are applied. As shown in FIG. 1, the walking robot includes a body 10, and two legs 11L and 11R respectively connected to both sides of the lower part of the body 10.

Each of the two legs 11L and 11R includes six joints in order to walk. That is, the two legs 11L and 11R respectively include joints 21L and 21R installed at a hip of the body 10, each to swivel the corresponding leg 11L or 11R around a Z axis, i.e., in a direction of gravity, joints 22L and 22R, each for roll rotation of the hip around an X axis, joints 23L and 23R, each for pitch rotation of the hip around a Y axis, joints 24L and 24R, each for pitch rotation of the knee around the Y axis, joints 25L or 25R, each for pitch rotation of the ankle around the Y axis, and joints 26L and 26R, each for roll rotation of the ankle around the X axis.

Further, the two legs 11L and 11R respectively include upper links 27L and 27R, which connect the hip joints 22L, 22R, 23L and 23R and the knee joints 24L and 24R, and middle links 28L and 28R, which connect the knee joints 24L and 24R and the ankle joints 25L, 25R, 26L and 26R. The ankle roll rotation joints 26L and 26R are respectively connected to feet 40L and 40R by lower links 29L and 29R.

Although not shown in the drawings, each of all the joints includes an electric motor to drive the joints, and the operations of the electric motors are controlled by a control unit (not shown) to control the robot. Further, the control unit, a battery (not shown), etc. are installed in the body 10.

Multi-axis F/T sensors 30L and 30R are respectively installed at connection portions between the feet 40L and 40R and the lower links 29L and 29R. The multi-axis F/T sensors 30L and 30R measure three-directional components Fx, Fy, and Fz of a force and three-direction components Mx, My, and Mz of a moment, transmitted from the feet 40L and 40R, and thus detect whether or not the feet 40L and 40R land and detect load applied to the feet 40L and 40R. An inclination sensor 31 detecting inclination and angular velocity relative to the gravity direction, i.e., the direction of the Z axis, is installed in the body 10. Further, various sensors (not shown) controlling the operation of the robot may be installed in the body 10 and the legs 40L and 40R of the robot. Signals outputted from these sensors are inputted to the control unit. Then, based on the output values of the sensors and the data stored therein, the control unit computes driving amounts of the respective joints and controls the operations of the joints, thereby allowing the robot to desirably walk.

The feet 40L and 40R installed at the lower portions of the legs 11L and 11R are respectively connected to the multi-axis F/T sensors 30L and 30R connected to the lower links 29L and 29R. The two feet 40L and 40R connected to the legs 11L and 11R have the same shape. Thus, for the clear description, only one foot 40L will be stated below.

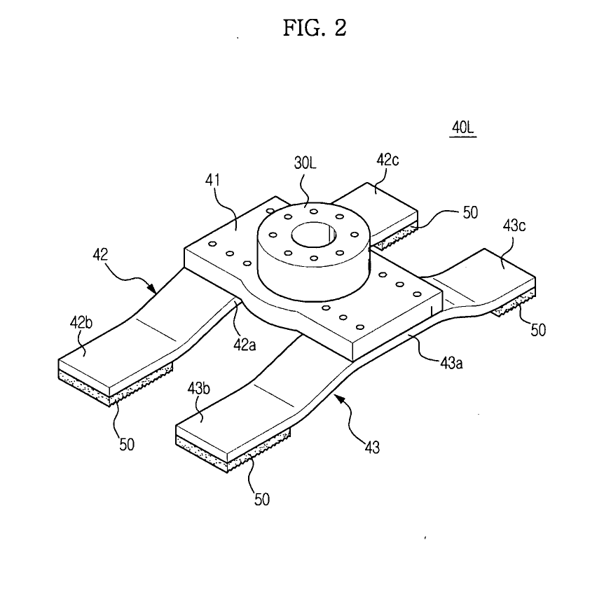

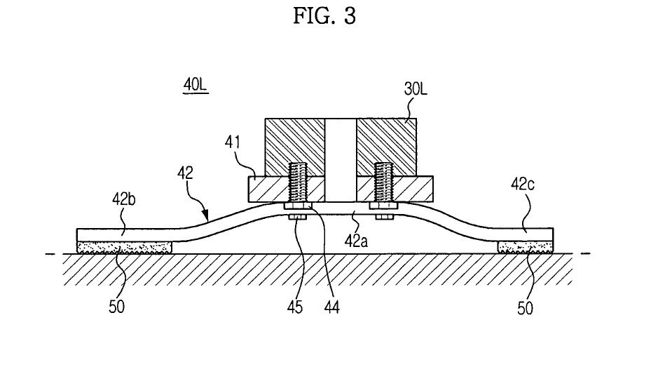

The foot 40L, as shown in FIGS. 2 and 3, includes a frame 41 connected to the multi-axis F/T sensor 30L, and first and second impact absorbing plates 42 and 43 having elasticity connected to the frame 41.

The frame 41 may have a form of a rectangular panel, in which the width in the transversal direction is longer than the length in the longitudinal direction, and may be made of a metal having a high rigidity, such as an aluminum alloy, for example. The central portion of the frame 41 may be connected to the multi-axis F/T sensor 30L using a plurality of fixing bolts 44, for example.

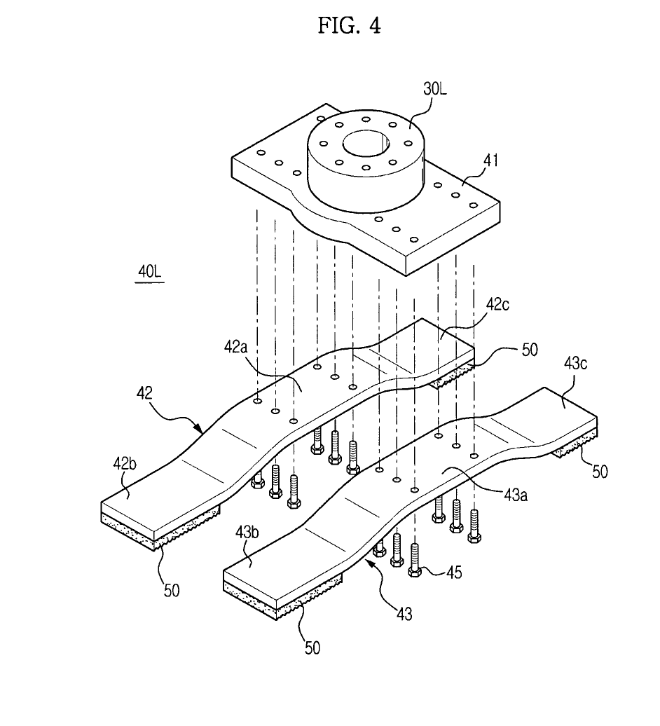

The first and second impact absorbing plates 42 and 43, as shown in FIGS. 2 to 4, have the form of a flat panel having a long length in the longitudinal direction. These impact absorbing plates 42 and 43 may be respectively connected to both sides of the lower surface of the frame 41 using a plurality of fixing screws 45, for example.

The first and second impact absorbing plates 42 and 43 respectively include separation parts 42a and 43a respectively connected to the lower surface of the frame 41 and separated from the ground, front ground parts 42b and 43b extended forward from the separation parts 42a and 43a to a designated length and contacting the ground, and rear ground parts 42c and 43c extended backward from the separation parts 42a and 43a to a designated length and contacting the ground. Portions connecting the rear and rear ground parts 42b, 43b, 42c, and 43c and the separation parts 42a and 43a are bent downward to be inclined at a specific degree.

When the first and second impact absorbing plates 42 and 43 are connected to both sides of the frame 41, as shown in FIG. 2, the two front ground parts 42b and 43b, are extended forward and are separated from each other, and the two rear ground parts 42c and 43c are extended backward and are separated from each other. Further, the separation parts 42a and 43a under the frame 41, as shown in FIG. 3, are separated from the ground. The separation parts 42a and 43a are separated at an upper region thereof by a separation region.

The two front ground parts 42b and 43b have a length in the longitudinal direction that is longer than that of the two rear ground parts 42c and 43c. Thus, a ground area of the two front ground parts 42b and 43b at which the front ground parts 42b and 43b contact the ground surface is larger than a ground area of the two rear ground parts 42c and 43c at which the rear ground parts 42c and 43c contact the ground surface. Such a configuration allows the robot, which moves mainly forward, to walk easily and be stably supported.

The lower portion of the frame 41 of the foot 40L is separated from the ground, and thus if there is an obstacle, which is smaller than the separation height, under the frame 41, i.e., the separation parts 42a and 43a, during walking, it is possible to prevent the foot 41L from contacting the obstacle. Further, the first impact absorbing plate 42 and the second impact absorbing plate 43 are separated from each other, and thus the two front ground parts 42b and 43b or the two rear ground parts 42c and 43c are separated from each other and the upper portion of the separation region is opened. Accordingly, even if there is an obstacle in a space between the two front ground parts 42b and 43b or the two rear ground parts 42c and 43c, it is possible to prevent the foot 40L from contacting the obstacle. It reduces a probability of contact between the obstacle and the foot 40L during walking, thus allowing the robot to achieve stable walking when the robot walks on an uneven ground. That is, the foot 40L is supported by the four ground parts 42b, 43b, 42c, and 43c rather than the entire sole, thereby minimizing contact with an obstacle and achieving stability in walking.

The first and second impact absorbing plates 42 and 43 may be made of carbon fiber reinforced plastic (CFRP), for example, having elasticity. However, the first and second impact absorbing plates 42 and 43 are not limited thereto and may be made of any material allowing for a level of elasticity. CFRP has a designated rigidity to stably support the robot, and has elasticity to increase an impact absorbing effect compared to a plate made of metal. Thus, CFRP effectively absorbs shock caused by landing subsequent to walking of the robot.

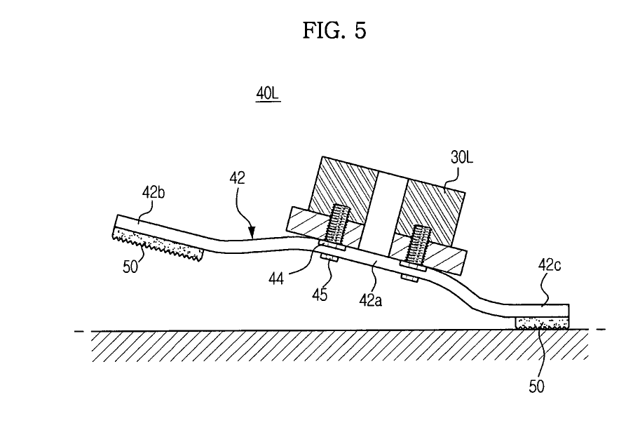

As shown in FIG. 5, the first and second impact absorbing plates 42 and 43 are slightly bent (elastically deformed) when landing, and thus absorb an impact. This impact absorbing effect is exhibited when the front ground parts 42b and 43b and the rear ground parts 42c and 43c are concurrently grounded, as shown in FIG. 3, as well as when the rear ground parts 42c and 43c are first grounded, as shown in FIG. 5. Therefore, the first and second impact absorbing plates 42 and 43 can alleviate the impact in various landing conditions.

Particularly, since the lower portion of the frame 41 of the foot 40L is separated from the ground, an impact applied perpendicularly to the sole of the foot 40L can be effectively alleviated. Thus, it is possible to prevent damage to the multi-axis F/T sensor 30L. Further, in the case that the rear ground parts 42c and 43c are first landed, as shown in FIG. 5, the rear ground parts 42c and 43c are highly bent at the initial stage of landing to absorb a great initial impact, and are restored to their original state after landing to stabilize the posture of the robot after landing. Further, since all the parts of the foot 40L are unified at an assembled state, the foot 40L easily controls the walking of the robot.

Buffering members 50 having a designated thickness are respectively attached to the lower surfaces of the two front ground parts 42b and 43b and the two rear ground parts 42c and 43c. The buffering members 50 may be made of a material having a high frictional force and an excellent elastically restoring force, such as rubber, for example, however, the buffering members 50 are not limited thereto and may be made of any type of material having a frictional force and an elastic restoring force. The buffering members 50 have a high frictional force, and thus prevent the robot from slipping during walking. Further, the buffering members 50 alleviate a small impact and vibration, transmitted to the respective ground parts 42b, 43b, 42c, and 43c due to the elasticity of the buffering members 50, and thus stabilize the walking of the robot.

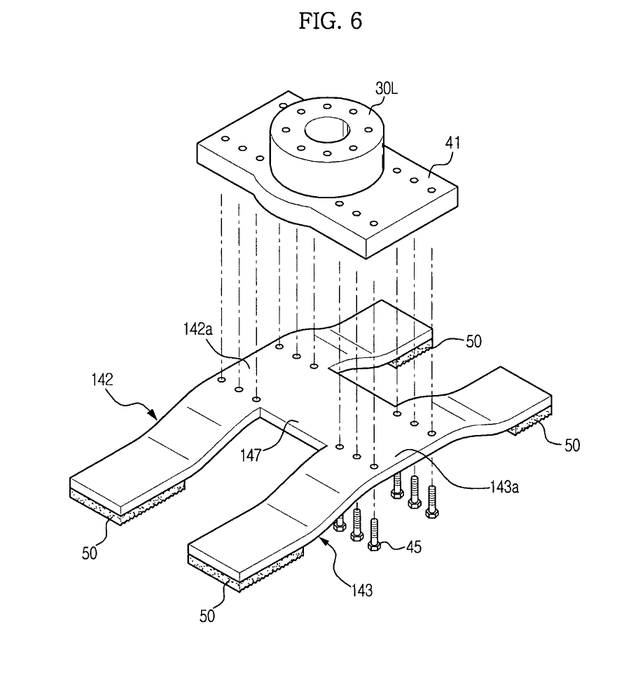

FIG. 6 is an exploded perspective view of a foot of a walking robot in accordance with a second embodiment. In the embodiment of FIG. 6, a first impact absorbing plate 142 and a second impact absorbing plate 143 are formed integrally. That is, separation parts 142a and 143a of the two impact absorbing plates 142 and 143 are connected by a connection part 147. Other constitutions and effects of this embodiment are substantially the same as those of the preceding embodiment, and a detailed description thereof will thus be omitted because it is considered to be unnecessary.

As apparent from the above description, the present embodiments provide a foot of a walking robot in which the lower portion of a frame is separated from the ground and plural ground parts contacting the ground are separated from each other to minimize contact with obstacles when walking, and a walking robot having the same. Thus, the foot of the walking robot minimizes the tilting of the sole even when the robot walks on the uneven ground, thereby obtaining stability in walking.

Further, the foot of the walking robot of the present embodiments include plural impact absorbing plates, which are elastically deformed to absorb impact when landing, thus alleviating impact in various directions applied to the sole to an almost equal level. Particularly, since the lower portion of the frame is separated from the ground, the foot of the walking robot increases the alleviation of an impact applied perpendicularly to the sole, and thus minimizes damage to a sensor installed at the ankle.

Further, when the rear ground parts are first landed, the rear ground parts of the foot are highly bent at the initial stage of landing to absorb a great initial impact, and are restored to their original state after landing to stabilize the posture of the robot after landing.

Further, since almost all parts of the foot of the walking robot of the present embodiments are unified at an assembled state, the foot easily controls the walking of the robot.

Although embodiments have been shown and described, it would be appreciated by those skilled in the art that changes may be made in these embodiments without departing from the principles and spirit of the invention, the scope of which is defined in the claims and their equivalents.

What is claimed is:

1. A foot of a walking robot to walk on a ground surface, the walking robot including a leg, the foot comprising:
a frame connected to a lower portion of the leg of the walking robot; and
a plurality of impact absorbing plates having elasticity respectively connected to two sides of the frame such that the impact absorbing plates are separated from each other, each of the impact absorbing plates including a separation part connected to the frame and separated from the ground surface, a front ground part extended forward from the separation part and contacting the ground surface, and a rear ground part extended backward from the separation part and contacting the ground surface.

2. The foot according to claim 1, wherein the front and rear ground parts of the impact absorbing plates are separated from each other, and an upper portion of a separation region between the impact absorbing plates is opened.

3. The foot according to claim 1, further comprising buffering members respectively attached to lower surfaces of the front and rear ground parts of the impact absorbing plates.

4. The foot according to claim 3, wherein the buffering members are made of rubber having elasticity.

5. The foot according to claim 1, wherein the impact absorbing plates are made of carbon fiber reinforced plastic (CFRP).

6 The foot according to claim 1, wherein a ground area of the front ground parts at which the front ground parts contact the ground surface is larger than a ground area of the rear ground parts at which the rear ground parts contact the ground surface.

7. The foot according to claim 1, wherein a length of each of the front ground parts is longer than a length of each of the rear ground parts.

8. A walking robot, comprising:
a body;
a plurality of legs connected to the body to cause the robot to walk on a ground surface; and
feet respectively connected to lower portions of the legs, each of the feet including a frame connected to the lower portion of one of the legs of the walking robot, and a plurality of impact absorbing plates having elasticity respectively connected to two sides of the frame such that the impact absorbing plates are separated from each other, each of the impact absorbing plates including a separation part connected to the frame and separated from the ground surface, a front ground part extended forward from the separation part and contacting the ground surface, and a rear ground part extended backward from the separation part and contacting the ground surface.

9. The walking robot according to claim 8, wherein the front and rear ground parts of the impact absorbing plates are separated from each other, and an upper portion of a separation region between the impact absorbing plates is opened.

10. The walking robot according to claim 8, wherein each of the feet further includes buffering members respectively attached to lower surfaces of the front and rear ground parts of the impact absorbing plates.

11. The walking robot according to claim 10, wherein the buffering members are made of rubber having elasticity.

12. The walking robot according to claim 8, wherein the impact absorbing plates are made of carbon fiber reinforced plastic (CFRP).

13. The walking robot according to claim 8, wherein a ground area of the front ground parts at which the front ground parts contact the ground surface is larger than a ground area of the rear ground parts at which the rear ground parts contact the ground surface.

14 The walking robot according to claim 8, wherein a length of the front ground parts is longer than a length of the rear ground parts.

15. The foot according to claim 1, wherein the impact absorbing plates are formed integrally such that a separation part of each of the impact absorbing plates is connected to a separation part of another of the impact absorbing plates at a connection part.

16. The walking robot according to claim 8, wherein the impact absorbing plates are formed integrally such that a separation part of each of the impact absorbing plates is connected to a separation part of another of the impact absorbing plates at a connection part.

17. A foot of a walking robot to walk on a ground surface and having a body, the foot comprising:
at least one plate supporting the body of the walking robot, the plate having a separation part separated from the ground surface and a plurality of ground parts extending away from the separation part to contact the ground surface.

18. The foot according to claim 17, wherein each of the ground parts includes a buffering member having an elastic restoring force to cushion an impact of the foot contacting the ground surface.

19. The foot according to claim 17, wherein a sensor is connected between the foot and the body of the robot and is supported by the plate, the sensor measuring three-dimensional components of a force and three-dimensional components of a moment transmitted from the foot.

20. The foot according to claim 19, further comprising a frame, the frame being supported by the at least one plate and supporting the sensor.
